(19) United States
(12) Patent Application Publication
(10) Pub. No.: US 2009/0199037 A1
(43) Pub. Date: Aug. 6, 2009

(54) Wake-up timer with periodic recalibration

(76) Inventors: Narasimhan Venkatesh, Hyderabad (IN); Subba Reddy Kallam, Hyderabad (IN); Alukuru Trikutam Sivaram, Hyderabad (IN)

Correspondence Address: Jay Chesavage, 3833 Middlefield Rd., Palo Alto, CA, 94303, US

(21) Appl. No.: 12/024,748

(22) Filed: Feb. 1, 2008

(51) Int. Cl. G06F 1/06; G06F 1/32

(52) U.S. Cl. 713/502

(57) ABSTRACT

A power saving sleep timer has a first clock and a second clock having greater frequency and temporal stability than the first clock. The second clock has an associated second clock period value which is accumulated once for each said second clock interval during one or more first clock periods, thereby forming a calibrated period value. During an operational interval, the calibrated period value is accumulated once per first clock interval until the accumulated value is equal or greater than a sleep time value, after which a power-up output is asserted.

### FIELD OF THE INVENTION

The present invention relates to a power-up sleep timer for use in power-saving devices that power-down most parts of the device and then waits an accurate interval of time during which most parts of the device are powered down, after which a power-up output is generated which brings the device back to full operation.

### BACKGROUND OF THE INVENTION

Handheld or portable electronic devices are seen in many forms today. Mobile phones, cameras, portable audio and video players, VoIP phones, gaming devices, and others are all examples of such utility devices with a common need to maximize battery life. Most of these devices also need a means to communicate with an external data server or the internet. This connectivity is often provided by a Wireless LAN (WLAN) module that is incorporated in the device.

WLAN provides data transport following a protocol described in various standards, but primarily in the IEEE 802.11 Wireless Local Area Network standard. The WLAN protocol provides a way to connect the client or handheld device, also called ‘station’, to an ‘Access Point’ (AP) using a wireless link, as shown in FIG. 1. A station such as 102 becomes known to the AP 104 using an association protocol, and then joins the Basic Service Set (BSS) that is set up by the AP. A BSS may also exist without an AP, in which case it is an Independent BSS (IBSS).

Once connected to a BSS, the station may transmit or receive data over the wireless medium. The method of sharing the medium is laid out in a set of rules in the standard that define the Medium Access Control (MAC) mechanism of the IEEE 802.11 family of standards, including 802.11a, 802.11b, 802.11g, and many others not listed. For example, a station which finds that it has data that must be transmitted observes the medium to determine whether or not it is being currently used. If it is in use, the station waits until any current packet transfer has completed. The station then determines the period of occupancy by decoding data transmitted at the beginning of a frame. FIG. 2 shows an example of packet exchange between an AP such as 104 of FIG. 1 and a Station such as 102 of FIG. 1. The AP 104 sends a data packet with a sequence number k, which is acknowledged (ACK) by the station. Separately, the station may send a data packet with sequence number m, after which the receiving AP sends an ACK for this data packet.

FIG. 3 shows a WLAN power save implementation, where the AP sends beacon packets 302, 304, and 306, which are followed shortly by a packet with a destination address for a particular station, shown for the AP sending packets for STA-1 and STA-2 after beacon packets 302 and 306, respectively. In the present example, station STA-1 need only be active during a sufficient duration after beacon 302 to send or receive packets to and from the AP, and long enough during subsequent beacons 304 and 306 to determine that it will not be receiving packets following those beacons. Similarly, station STA-2 is active during beacons 302 and 304 only long enough to determine there are no packets for it, and long enough during beacon 306 to receive the beacon 306 and the packets destined for STA-2. The power saving mechanism available to the WLAN relies on the fixed time interval T1 between beacons, which are also known as Delivery Traffic Indication Message (DTIM). By listening only during the beacon interval and powering down at other times, the WLAN may save significant amounts of power, resulting in correspondingly improvement in battery lifetime.

When there are no applications active at the handheld station that require the transfer of data, the entire WLAN module need not be active. When a module, or a portion of a chip of the module, is active, it consumes power, whereas one of the primary design goals of a battery-operated device is to minimize the consumption of power.

The 802.11 standard provides a mechanism using which the station may remain inactive, or in a ‘sleep’ mode, for a period of time. During this sleep period, any data packets destined for that station would be kept in storage at the AP 104 of FIG. 1 to be delivered when the station wakes up at a predetermined time T1 associated with a subsequent beacon which arrives at time T1 following the previous beacon.

In a semiconductor implementation of a WLAN station module, it is common practice to turn off most of the internal circuitry during this sleep period. However, since the module must wake up at the end of a predetermined time period, systems often use a dedicated timer running during the sleep interval that generates a ‘wake up’ signal, which is used to enable power to the rest of the circuitry. In CMOS semiconductors, the frequency, or rate, of a clock signal is directly related to the power consumption of the circuitry that uses the clock. Hence it is common practice to run the separate sleep timer at a low clock rate such as 32 kHz while the remainder of the WLAN circuitry is powered down. A 32 kHz clock frequency is particularly attractive in prior art systems due to the availability of low-cost crystals that support that frequency.

FIG. 4 illustrates a power-save implementation in a prior art wireless receiver 400, which comprises digital integrated circuit (IC) functions 404 which may comprise a single digital IC or multiple digital ICs, and external functions 402 which may be analog functions such as RF transceiver 412 and antenna 413, reference oscillator 414, optionally analog front end 418, and wake-up timer 406 comprising a low frequency oscillator 406 and timer 410 with a programmable delay time. A power management system 416 is under control of the timer 410, and either selectively enables power or unasserts a standby mode to the analog front end 418, RF transceivers 412, reference oscillator 414, media access controller (MAC) 420, broadband processor 422, and system clock generator 424, which provides a system clock to all of the components of the WLAN MAC-BBP chip 404.

Among the disadvantages of the prior art communications receiver of FIG. 4 are additional cost due to the external crystal oscillator 408, additional size of the device due to the external components 406, and additional power consumption due to the crystal oscillator 408 and the transport of clock signals across a chip boundary.

A way of mitigating these disadvantages is to use an oscillator internal to the chip. It is known that within a semiconductor device, one may connect buffers or other components to create an oscillator by employing a positive feedback mechanism, such as shown in FIGS. 5A and 5B and described in application note AN-118 by Fairchild Semiconductor. Compared to a crystal oscillator such as 408 of FIG. 4, the oscillators of FIGS. 5A and 5B suffer from a wide variation in the frequency of their output depending on temperature. Temperature and applied voltage conditions in the chip heavily affect the Td response times of the internal circuits and change the resultant frequency of operation of the oscillator. An inaccurate oscillator would not in itself affect the functionality of the WLAN module, but it would severely affect the potential savings in power that would be possible through maximizing the sleep intervals. The WLAN power-save protocol, as shown in FIG. 3, requires the station to wake up at a predetermined interval, marked by beacons or multiples of beacon intervals called Delivery Traffic Indication Message (DTIM), to check whether the AP has any packets queued up for it. A lack of ability to accurately time this wake-up would mean that the WLAN module would have to be activated sufficiently in advance of the DTIM so as to be sure to receive the AP's beacon and message. There is a wide variation in the frequency of an uncompensated oscillator due to temperature as well as manufacturing process variations—up to 40% variation. To accommodate this variation, the wake-up time would have to be programmed sufficiently in advance so as to not miss the DTIM and this would result in a severe loss of power savings given the wide variation in the sleep clock frequency.

U.S. Pat. No. 7,218,911 shows a timer which calibrates a sleep oscillator using a reference oscillator.

U.S. Pat. No. 7,224,970 describes a WLAN which uses a timed window scanning procedure to wakeup and scan for a beacon.

U.S. Pat. No. 7,292,545 describes a system for placing a system into a power save mode until shortly prior to the arrival of a beacon.

U.S. Pat. No. 7,133,944 describes a wakeup timer for a media access controller MAC in a WLAN system.

### OBJECTS OF THE INVENTION

A first object of this invention is a calibrated timer having:

a first oscillator with a temporal variation in frequency;

a second reference oscillator and an associated refclk value substantially equal to the period of said second reference oscillator;

a first accumulator which accumulates the refclk value into a register for a duration of time equal to the period of the first oscillator, thereafter saving this value into a period store;

a second accumulator which adds the period store value on each first oscillator period;

a comparator that compares the second accumulator value with a sleep time, and asserting a power-up indicator when the second accumulator value is equal or greater than said sleep time.

A second object of the invention is a power-on generator having an on-chip oscillator that accepts a calibrated accumulation result into a register by forming a timing result from the on-chip oscillator using a calibration standard clock, where the calibrated accumulation result represents an integer and fractional part the period of the on-chip oscillator, and an accumulator adds the calibrated accumulation result every on-chip clock cycle until a threshold value having an integer microsecond and fractional microsecond part is met or exceeded.

### SUMMARY OF THE INVENTION

The present invention has a calibration interval and a standby interval. During the calibration interval, a first (on-chip) clock source is used in combination with a second (reference) clock source having inherently greater temporal and absolute accuracy than the first clock source, and the second clock source additionally has a frequency more than 100 times greater than the first clock source. The second clock source is associated with a second clock period value representing the period of the second clock source. During a measurement interval derived from the period of the first clock, the second clock source period value is added into a first accumulation register each second clock cycle, the first accumulation register cleared at the beginning of the calibration interval, such that at the end of the calibration interval, a calibrated period value representing the integer and fractional parts of the second first clock source are stored. During the standby interval, the contents of the calibrated period value register are successively added with each first clock cycle into a second accumulation register and compared with a sleep time value, such that after the second accumulation register is equal to or greater than the sleep time value, a power-up output is asserted. By using a second clock period value associated with the second clock period, the first accumulation register contains an integer and fractional part of the period of the first clock period. The sleep time value provided to the comparator is thus independent of the frequency of the second clock.

### BRIEF DESCRIPTION OF THE DRAWINGS

FIG. 1 shows a prior art WLAN topology including access points (AP) and stations (STA).

FIG. 2 shows the timing relationship between the AP and STA during a packet exchange.

FIG. 3 shows a timing diagram related to wireless packets when the AP uses beacons.

FIG. 4 shows the block diagram for a prior art communications receiver with a sleep timer.

FIGS. 5A and 5B show diagrams for a ring oscillator and an RC oscillator, respectively.

FIG. 6 shows a block diagram for a communications receiver using an on-chip oscillator with a calibrated power-up timer.

FIG. 7 shows an on-chip oscillator and circuitry which provides a delay in micro-seconds and fractional micro-seconds.

FIG. 8 is a timing diagram of the detail shown in FIG. 7.

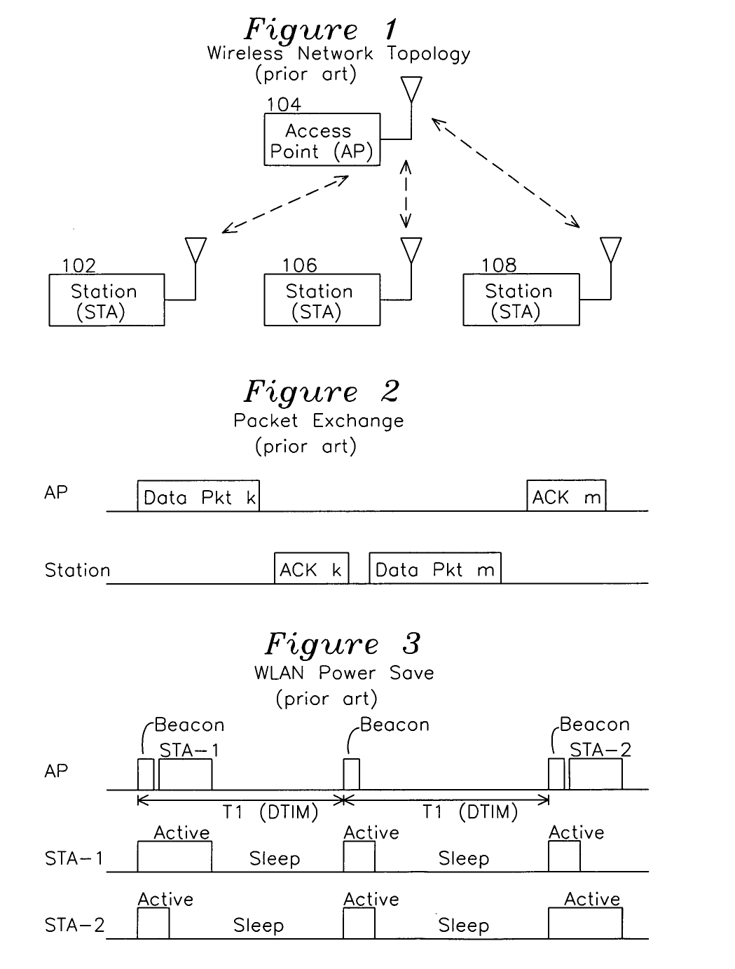

### DETAILED DESCRIPTION OF THE INVENTION

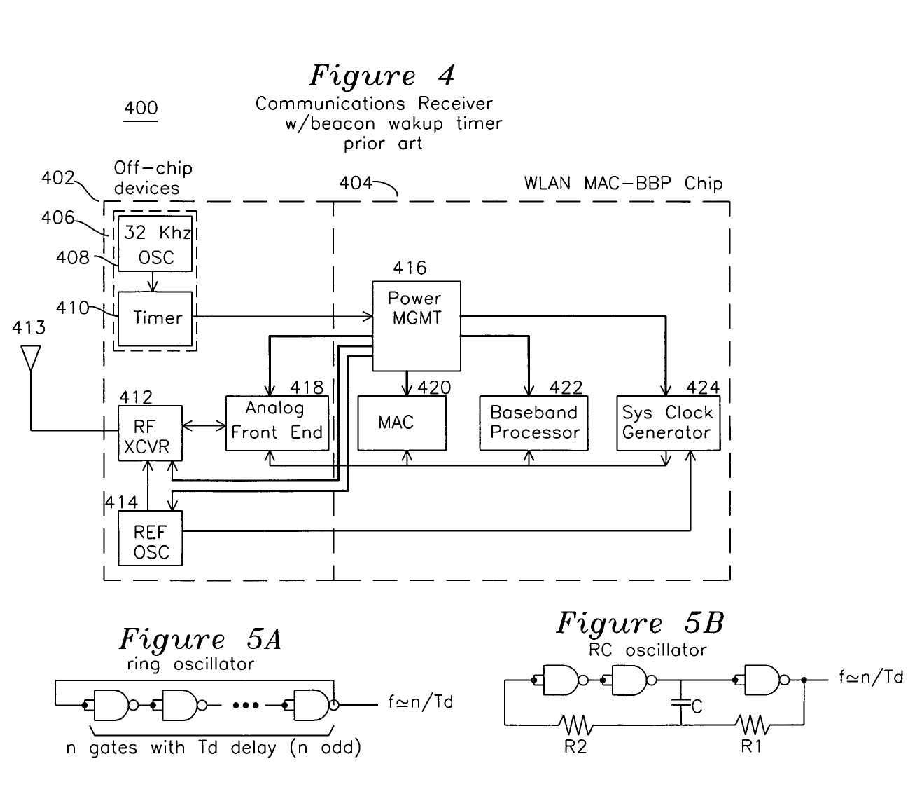

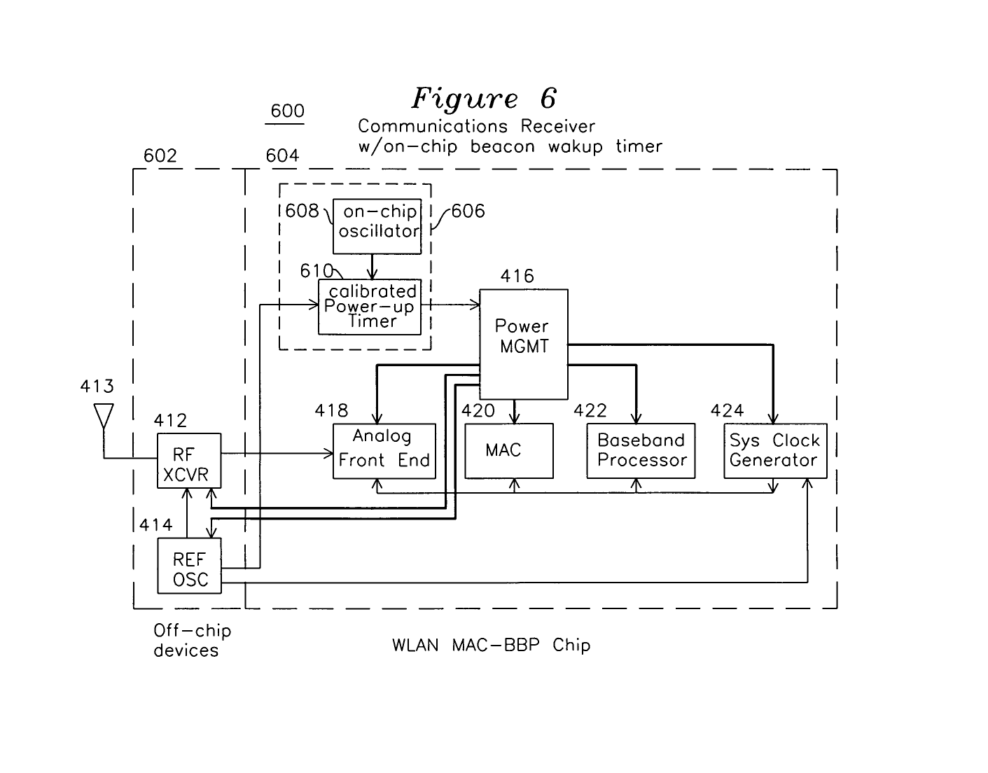

FIG. 6 shows the various components of a handheld device 600 operable for a WAN, including the wake-up timer 606 of the present invention. As described previously, the off-chip devices 602 include the RF transceiver 412 coupled to antenna 413, where the transceiver receives clock signals from reference oscillator 414, which typically has stability on the order of 20 ppm and a frequency of operation in the range of 10 Mhz to 50 Mhz. As was described previously for FIG. 4, the power management controller 416 enables analog front end 418, MAC 420, Baseband processor 422, and system clock generator 424, which typically generates clock signals using a PLL or other clock generation technique. In the present invention, the system clock generator 424 also has desirable properties of frequency stability, although the reference oscillator 414 which is used for transmit modulation typically has the best frequency stability, phase noise, and temperature and operating voltage independence, thereby providing the best measurement accuracy. During normal activity, the WLAN module 600 is fed with various clocks from a PLL based clock generator 424. One or more such PLLs are given a frequency reference from an external stable crystal oscillator. Since a primary design goal of such systems is the minimization of power consumption, the system incorporates detailed power control, with various portions of the chip or external components being switched off when not needed, as was described in association with the beacon packets of FIG. 3.

The WLAN standards require the operating clocks in the system, particularly the clocks used by the baseband processor, that deal with the conditioning of signals to be transmitted through the wireless link and with the extraction of data from incoming signals from the RF transceiver to be stable and accurate to within 20 ppm of a global standard. Due to this requirement, devices that incorporate WLAN use crystal oscillators that provide an accuracy of 20 ppm or better. This accuracy is guaranteed across all temperature conditions through internal compensation mechanisms.

The timer 606 of the present invention relies on the use of a stable and accurate frequency reference which is available in the WAN system 600, specifically via reference oscillator 414 or system clock generator 424, and which can be used to calibrate or compensate the internal on-chip oscillator 608.

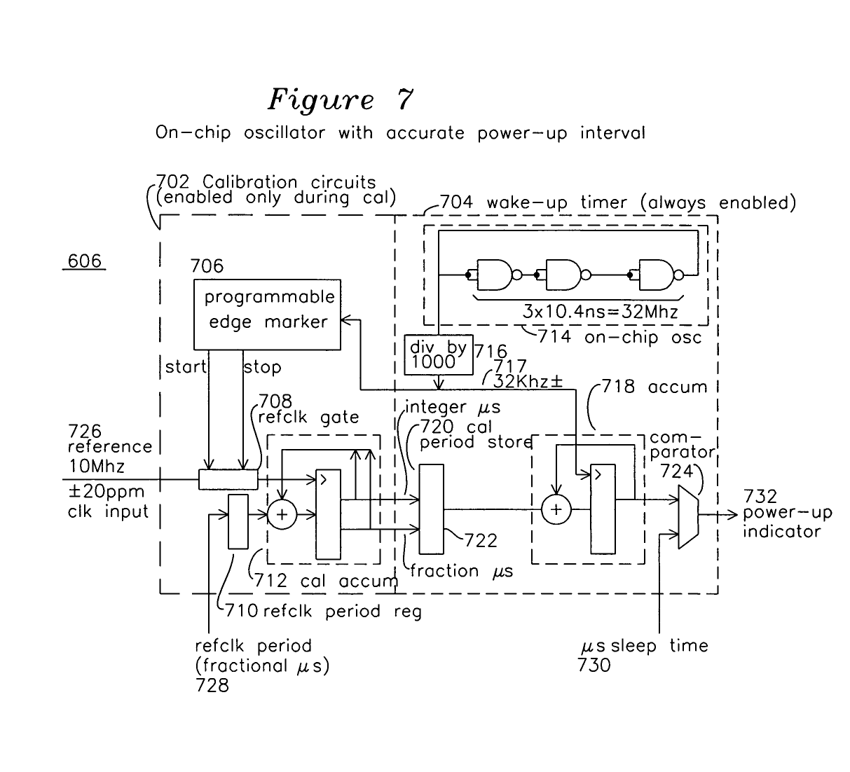

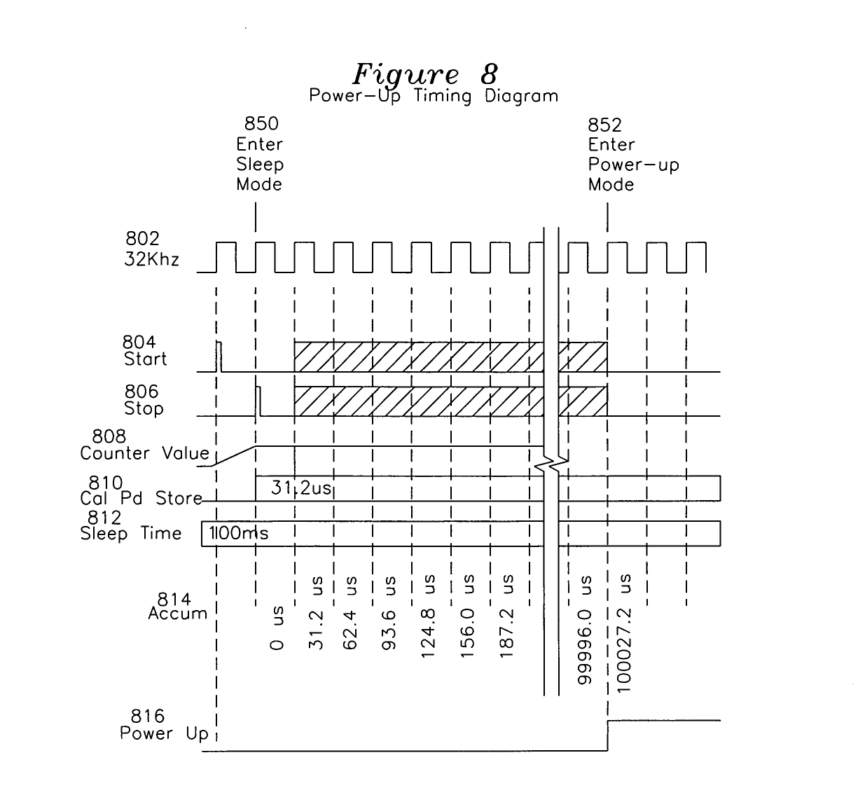

FIG. 7 shows the details of the timer 606 of FIG. 6. A first clock 717 is produced by an on-chip oscillator 714, shown having a frequency of 32 Mhz, which is followed by divider 716 having a 1:1000 divide ratio, thereby producing a first clock 717 with a frequency in the present example of 32 Khz. As was described earlier, the first clock 717 is not time or temperature stable, as the frequency depends on propagation and delay times in on-chip ring oscillator 714. The thermal mass of the on-chip oscillator and related WLAN system components results in slowly changing temperature and therefore frequency drifts of the on-chip oscillator 714 from one beacon to the next, and variations in system voltage which cause frequency drifts are also slowly varying. The first clock oscillator can be any inexpensive clock oscillator known in the prior art, and is shown as a ring oscillator 714 and divider 716 for illustration. The first clock source 717 is provided to a calibration part 702 which also accepts a second clock 726 from a reference source such as a transmit clock oscillator or a system reference clock for a WLAN. The frequency of the second clock should be more than 100 times the frequency of the first clock for best accuracy. Associated with the second clock is a second clock period value 728, which may be saved in a refclk period register 710. During a calibration interval, which may be any multiple of first clock 717 cycles, the refclk period register 710 value is accumulated 712 by successively adding the second clock period value 728 once each second c-lock cycle during the calibration interval. At the end of the calibration interval, the final value stored in the first accumulator 712 is provided as a calibrated period value to storage 722. As the second clock period register 728 contains a fractional measurement which is added over the many second clock cycles of a first clock period, the calibrated period value has an integer and a fraction part. For example, for a 32 Khz (31.25 us period) first clock and a second (refclk) clock of 10 Mhz (0.1 us), the second clock period value 728 would be 0.1 us (fractional part only). This value is saved in register 710, and during one first clock interval time, as determined by programmable edge marker 706 which generates a start and stop signal to refclk gate 708, a first accumulator 712 adds the refclk value of 0.1 us every second clock cycle, producing a final accumulator value of 31.25 us at calibrated period store 720. For the same first clock frequency, if the second clock were 13 Mhz (with a period of 0.0769 us), the second clock period value 728 would be 0.0769 (fractional part only), and at the end of 406 second clock cycles representing the duration of a first clock cycle, the first accumulator value would also be 31.25 us. If the first clock oscillator drifted to 33 Khz (30 us), the number of second clock samples would decrease to 30.0 us, representing the measured value of the first oscillator, and this value would be placed in period store 720. In this manner, the calibration part of the on-chip oscillator 606 produces a measurement for the time period for the first clock and saves it in calibrated period store 720.

During operation as a wake-up timer during a sleep interval, the calibration part 702 may be powered down, and calibrated period store 720 value is added every first oscillator cycle to second accumulator 718. The output of the second accumulator 718 is compared with a sleep time value 730, and when the comparator 724 second accumulator 718 value exceeds the sleep time 730, the power-up output 732 is asserted.

FIG. 8 shows the waveforms for FIG. 7. The first oscillator, or on-chip oscillator final output 32 Khz is shown in waveform 802. The interval from start 804 to stop 806 represents a calibration interval, during which time the second clock period value is added and accumulated, as shown in waveform 808. At any time after the end of the first clock calibration cycle, the device may enter sleep mode 850, after which the second accumulator successively adds the first clock period value, shown in integer and fractional components 814 which continues until a threshold such as 100 ms is passed at time 852. After the comparator indicates that the second accumulator value is equal to or exceeds the sleep time 812, the power-up waveform 816 is asserted at time 852, and the device leaves sleep mode and enters an operational mode.

The IEEE 802.11 protocol also defines a mechanism for enabling power-saving at a finer level of granularity when a station is carrying traffic of known periodicity—for example a voice connection. This mechanism, called Unscheduled Automatic Power Save Delivery, or UAPSD, enables a station, when it wakes up, to send a trigger frame to the AP whenever it finds that it has to send a packet or when it's time for it to receive a packet. This service is available only to certain traffic categories—in particular voice and video. The AP then immediately responds with any packets of the same traffic category that may be pending for the station without waiting for a DTIM interval. Such alternate timer values may also be supported by the selection of appropriate sleep times 730.

The figures and description of the invention provide one example of how the invention might be practiced. For example, if the wireless device is a wireless handset, then the reference transmit clock such as 10 Mhz transmit oscillator, system reference clock, or any other quartz crystal oscillator having greater temporal frequency stability and short or long term accuracy may be used as the refclk second clock. The first clock will typically be simpler and have lower power consumption than the refclk second clock, and the first clock will have lower frequency and greater frequency instability than the second clock oscillator, which may be implemented as a ring oscillator or an RC oscillator, or any inexpensive oscillator.

The operation of the device is shown for a WLAN for illustrative purposes only. As the invention only requires a continuously running first clock and periodic access to a second clock having greater accuracy that the first clock, the invention can be practiced with the second clock having an associated second clock period value and a first accumulator sums the second clock period value over one or more periods of the first clock, thereby generating a calibration period value, and then adding into a second accumulator the calibrated period value, comparing the second accumulator total with a sleep time value. In this manner, any type of portable device which needs a wake-up timer or a sleep timer for use in enabling or disabling power consuming circuitry for finite periods of time may practice the invention.

We claim:

1) A timer having:
a first clock source;
a second clock source with a frequency more than 100 times the frequency of the first clock source, said second clock source also having greater temporal frequency stability and accuracy than said first clock source, said second clock source associated with a second clock period value;
during a calibration interval, said second clock period value being added to a first accumulator value once every cycle of said second clock, thereby forming a calibration period value;
during an operational interval, said calibration period value being added to a second accumulator value once each cycle of said first clock, said accumulator value being compared to a sleep time value, and when said accumulator value exceeds said sleep time value, asserting a wake-up output.

2) The timer of claim 1 where said first clock source is a ring oscillator.

3) The timer of claim 1 where said first clock source is an RC oscillator.

4) The timer of claim 1 where said first clock source is a ring oscillator coupled to a divider which provides said clock source.

5) The timer of claim 1 where said second clock source is a WLAN system reference clock for transmitting data in a WLAN.

6) The timer of claim 1 where said second clock source is based on the resonant frequency of a quartz crystal.

7) The timer of claim 1 where said second clock period value is saved as fractional microseconds.

8) The timer of claim 1 where said first accumulator value has an integer microsecond part and a fractional microsecond part.

9) The timer of claim 1 where said second accumulator value has an integer microsecond part and a fractional microsecond part.

10) The timer of claim 1 where during said operational interval, said first accumulator and said second clock source are disabled.

11) A timer having:
a first clock source;
a calibration part accepting said first clock source and also a second clock source with a frequency and temporal stability greater than said first clock source, said second clock source associated with a second clock period value, said calibration part operative over a calibration interval during which said second clock period value is added once each said second clock cycle into a first accumulator, thereby producing a calibrated period value at the end of said calibration interval, said calibration interval being an integral multiple of the period of said first clock source;
a wake-up timer part accepting said first calibrated period value, and successively adding said first calibrated period value to an accumulator each said first clock cycle, said accumulator compared to a sleep time value by a comparator asserting a power-up output when said accumulator value is equal to or greater than said sleep time value.

12) The timer of claim 11 where said first clock is generated by a ring oscillator.

13) The timer of claim 11 where said first clock is generated by an RC oscillator.

14) The timer of claim 11 where said first clock is generated by a ring oscillator having a frequency greater than 32 Khz coupled to a divider.

15) The timer of claim 11 where said second clock is derived from a quartz crystal.

16) The timer of claim 11 where said second clock is derived from a WLAN system reference clock source.

17) The timer of claim 11 where said second clock period value is fractional microseconds.

18) The timer of claim 11 where said first accumulator value has an integer microsecond part and a fractional microsecond part.

19) The timer of claim 11 where said second accumulator value has an integer microsecond part and a fractional microsecond part.

20) A timer for a wireless LAN system having a reference clock and an on-chip clock with lower frequency and temporal stability than said reference clock, the timer having:
a calibration part which measures said on-chip clock by accumulating a reference clock period value during said reference clock for one or more intervals of said on-chip clock, thereby generating a calibrated period value;
a wake-up timer part which accumulates said calibrated period value every said on-chip clock cycle and compares the accumulated value with a sleep time value, asserting a power-up output when said accumulated value is equal to or greater than said sleep time value.
